(19) United States
(12) Patent Application Publication
(10) Pub. No.: US 2026/0252558 A1
(43) Pub. Date: Aug. 27, 2026

(54) PROVIDING FEEDBACK ON CHAIN OF THOUGHT REASONING FOR MODEL FINE TUNING

(71) Applicant: Aible Inc., Pleasanton, CA (US)

(72) Inventors: Arijit Sengupta, Las Vegas, NV (US); Jonathan Wray, Lago Vista, TX (US); Joseph Veltkamp, Corte Madera, CA (US); Frank Taylor, San Francisco, CA (US); Richard Cooke, Hayward, CA (US)

(21) Appl. No.: 19/546,186

(22) Filed: Feb. 20, 2026

Related U.S. Application Data
(60) Provisional application No. 63/763,818, filed on Feb. 26, 2025.

(51) Int. Cl. G06F 16/2452; G06F 16/2457

(52) U.S. Cl. CPC G06F 16/24522; G06F 16/24578

(57) ABSTRACT

A method for improving training artificial intelligence based models may include providing an artificial intelligence based reasoning sequence comprising one or more artificial intelligence reasoning sub-steps, wherein the artificial intelligence based reasoning sequence is associated with an analytical task executed by an artificial intelligence based model. The process can be configured to receive feedback from a user for a sub-step of the one or more artificial intelligence reasoning sub-steps and may re-train the artificial intelligence based model based on the feedback received from the user for the sub-step. Related apparatus, systems, techniques, and articles are also described.

### CROSS REFERENCE TO RELATED APPLICATIONS

This application claims priority to U.S. Provisional Patent Application No. 63/763,818, filed February 26, 2025, and entitled “Providing Feedback on Chain of Thought Reasoning for Model Fine Tuning,” the entire disclosure of this application is incorporated herein by reference.

### TECHNICAL FIELD

The subject matter described herein relates to improved training of artificial intelligence (AI) based models and improved response generation by AI models and agents.

### BACKGROUND

Some artificial intelligence (AI) based models are black-boxes, in that the internal workings of the process and sub-determinations that the AI based model uses to generate their output remain difficult to understand. Accordingly, when applying fine-tuning or other model training methods a user may be limited in providing useful training data because they are able to provide feedback only on the output of the model rather than the sub-determinations and reasoning steps taken by the model.

### SUMMARY

In an aspect, a method includes: providing an artificial intelligence-based reasoning sequence comprising one or more artificial intelligence reasoning sub-steps indicative of a logical process executed by an artificial intelligence based model to execute an analytical task; receiving feedback from a user for a sub-step of the one or more artificial intelligence reasoning sub-steps; and generating a revised response for the analytical task by re-executing the artificial intelligence based model based on the received feedback.

One or more of the following features can be included in any feasible combination. For example, the analytical task may include processing structured or unstructured data to generate an analytical output. Analytical output may include at least one of a classification, a prediction, a summary, an insight, a ranked list, or a recommended action. In some aspects, the logical process executed by the artificial intelligence based model to execute the analytical task can include interpreting a natural-language query; retrieving data relevant to the query from an information model or a database; applying one or more machine-learning-based or rule-based reasoning steps to the retrieved data; and generating a natural-language or structured response based on an output of the one or more machine-learning-based or the rule-based reasoning steps. In some aspects, the analytical task can include converting a natural-language question into a structured query language (SQL) statement; executing the SQL statement against a database to obtain a result set; and outputting an answer based at least in part on the result set.

In some aspects, the method can include feedback that includes data indicative of the artificial intelligence reasoning sub-step and the user provided feedback. Re-training can further include fine-tuning, distilling, or reinforcement learning of the artificial intelligence model. Re-training the model can include low-rank adaptation.

In some aspects, the artificial intelligence-based reasoning sequence is provided in a graphical user interface. Feedback can be provided by the user in the graphical user interface. For example, each of the one or more artificial intelligence reasoning sub-steps is displayed, and the graphical user interface further comprises one or more selectable icons associated with each sub-step and/or a textbox configured to receive user feedback.

In some aspects, the techniques described herein relate to a method, wherein the feedback from the user includes text input, and/or a selection of an icon.

In some aspects, the feedback from the user comprises SQL queries generated by the model, SQL query outputs, program code, python code, or textual outputs without chain-of-thought.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating improved training of an artificial intelligence model;

FIG. 2A is a system diagram for an example system for improved training of an artificial intelligence model;

FIG. 2B is a second system diagram for an example system for improved training of an artificial intelligence model.

FIG. 3 is a graphical user interface for improved training of an artificial intelligence model;

FIG. 4 is a graphical user interface for improved training of an artificial intelligence model;

FIG. 5 is a graphical user interface for improved training of an artificial intelligence model;

FIG. 6 provides an illustration of a platform for managing applications that interface with artificial intelligence based models;

FIG. 7 provides an illustration of some advantages for a system for improved training of an artificial intelligences model;

FIG. 8 is a graphical user interface for improved training of an artificial intelligence model;

FIG. 9 is a graphical user interface for improved training of an artificial intelligence model;

FIG. 10 is a graphical user interface for improved training of an artificial intelligence model.

Like reference symbols in the various drawings indicate like elements.

### DETAILED DESCRIPTION

Implementations of the current disclosure provide improved training of artificial intelligence (AI) based models.

An AI model can be trained to provide chain of thought reasoning. Chain of thought reasoning can refer to a model providing a user with a summary of the sequential logical steps that are taken when generating an output responsive to a user provided query. In the disclosed implementations, an AI based system can be configured to provide a user with not only responses to their queries but a sequential ordering of logical steps the AI model took to solve the prompt or problem presented by the user.

In some implementations of the current subject matter instead of receiving feedback only on the generated output from an AI model, the AI model can be configured to provide the user with the reasoning steps taken in the process of generating the output. As each reasoning step is provided to the user, the user can then provide additional feedback on each reasoning step. Accordingly, a user may have visibility into the reasoning steps taken by the AI model and provide feedback specific to each reasoning step. This may provide for accelerated learning and training of the AI-model.

In some implementations, an artificial intelligence based system can be improved to provide better responses by receiving feedback on chain of thought reasoning. The artificial intelligence based system can be improved by continuous validation of AI-generated responses through user-provided feedback to chain of thought reasoning. The artificial intelligence based system can also be improved through re-training of the underlying AI model using the user-provided feedback to the chain of thought reasoning. In some implementations, performance of the AI-models trained with varying sets of training data generated using the user-provided feedback to chain of thought reasoning can be evaluated and used to select appropriate training data and/or AI-models.

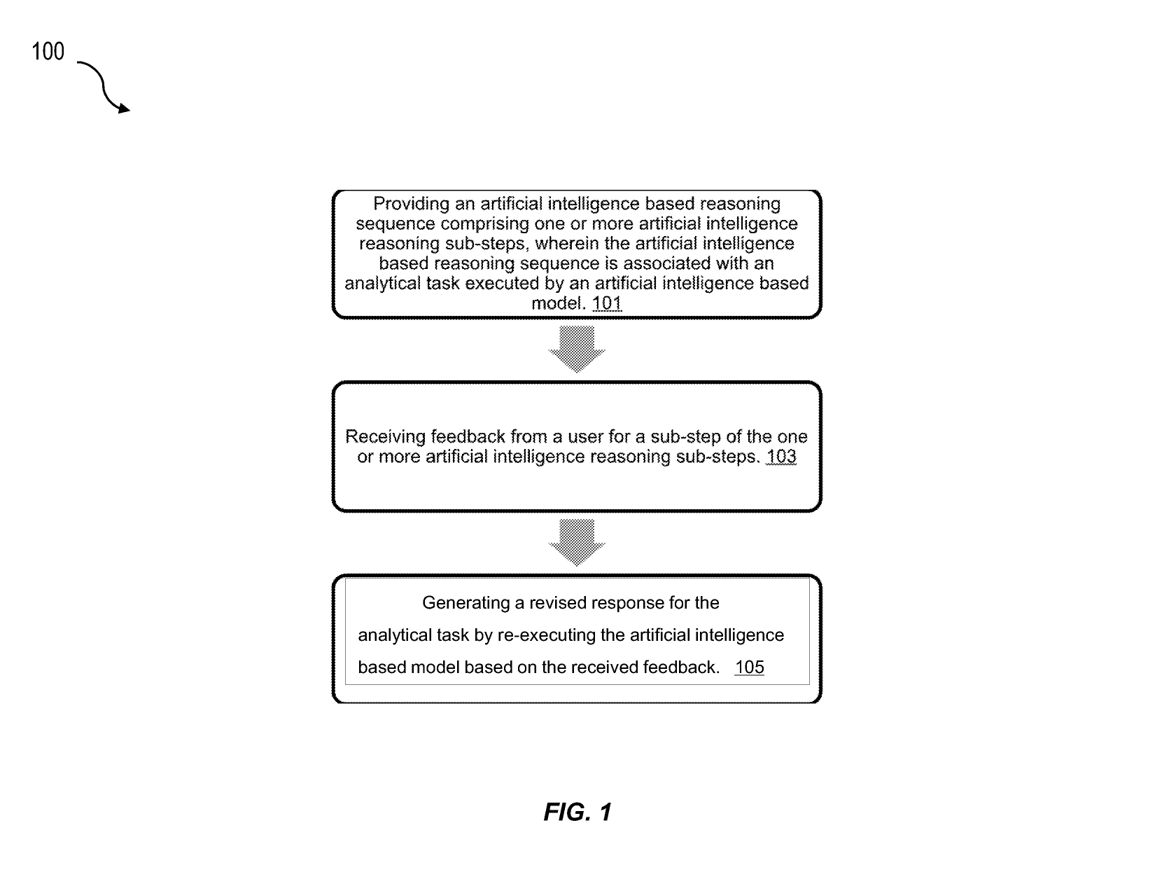

FIG. 1 is a process flow diagram illustrating improved training of an artificial intelligence model. As illustrated in FIG. 1, a process 100 can include the steps of providing an artificial intelligence based reasoning sequence comprising one or more artificial intelligence reasoning sub-steps, where the artificial intelligence based reasoning sequence is associated with an analytical task executed by an artificial intelligence based model 101. For example, the artificial intelligence-based reasoning sequence may include one or more reasoning sub-steps that are indicative of a logical process executed by an artificial intelligence based model to execute an analytical task. An analytical task may involve processing structured or unstructured data to generate an analytical output. Examples of analytical output include a classification, a prediction, a summary, an insight, a ranked list, or a recommended action. In some implementations, the logical process executed by the artificial intelligence based model to execute the analytical task may include interpreting a natural-language query, retrieving data relevant to the query from an information model or a database, applying one or more machine-learning-based or rule-based reasoning steps to the retrieved data, and generating a natural-language or structured response indicative of the analysis. In some implementations, the analytical task may involve converting a natural-language question into a structured query language (SQL) statement, executing the SQL statement against a database to obtain a result set, and outputting an answer based at least in part on the result set. In some implementations, the natural language question can be converted into program code such as python. The program code can be executed and an answer can be output based at least in part on the result of the program code execution. Other coding languages are possible.

In a second step of the process 100, a processor may receive feedback from a user for a sub-step of the one or more artificial intelligence reasoning sub-steps 103. Example feedback may be in the form of user selection of an icon or user input in a textbox. The feedback can characterize, for example, whether a given sub-step was accurate or not. The feedback can be in the form of a binary like or dislike (e.g., thumbs up or thumbs down) or can be in the form of a rating or score (e.g., 6 out 10) of the correctness or usefulness of the reasoning sub step, or a natural language description about why a given sub step is incorrect or deficient (e.g., an explanation from the user that a given subset is incorrect and why it is incorrect).

A third step of the process 100 may include generating a revised response for the analytical task by re-executing the artificial intelligence based model based on the received feedback 105. For example, the revised response can be generated by causing the artificial intelligence-based model to re-execute the analytical task using not only the original input query, but also the user-provided feedback associated with one or more reasoning sub-steps. The feedback may be incorporated into the re-execution pipeline in several ways, including for example by modifying intermediate reasoning constraints, adjusting model parameters or system settings for a single inference cycle, or injecting corrective natural-language or structured instructions into the model’s contextual input. In some implementations, the user feedback on a sub-step can be further processed and modified, for example, by using a generative model prior to use during the re-execution of the artificial intelligence based model.

In some implementations, the method can also include re-training the artificial intelligence based model based on the feedback received from the user for the sub-step. Re-training the artificial intelligence based model can include generating training data. The generated training data may include one or more of the original prompt, the initial reasoning sequence, the specific sub-step identified as incorrect, the user’s corrective feedback, and the revised response produced following re-execution. Training data can be aggregated across multiple users or sessions and used to update the underlying model through fine-tuning, distillation, reinforcement learning, or low-rank adaptation techniques.

The feedback provided by the users can be used to train models specific to a particular user or implemented across groups of users. Using feedback for each reasoning step, the underlying AI-model can be trained more efficiently. Reasoning steps and the obtained user feedback for the specific steps can be used to fine-tune, distill, or perform reinforcement learning on an AI-model.

In some implementations, a system can also include a user interface having a GUI that is configured to provide information related to the reasoning steps to a user, receive user provided feedback, and/or provide output from the artificial intelligence model to the user. User feedback can be provided in a graphical user interface using icons (e.g., thumbs up/thumbs down), sliders (e.g., good response, bad response), text boxes, and the like. In some implementations, the GUI may include a panel configured to display one or more inputs from a user such as a prompt or feedback. The GUI may also include a panel that displays one or more logical reasoning steps taken by the artificial intelligence model in generating an output or response to the user provided query or prompt. In some implementations, the GUI may include a plurality of icons each of which correspond to a reasoning step in the logical process and allow for user feedback for each reasoning step in the logical process by selection of an icon.

By allowing a user to provide feedback on sub-steps, the disclosed implementations may allow for greater specificity for the provided feedback. While in some conventional systems feedback can be provided as a binary designation that an output is good or bad, in some implementations described herein, the feedback may provide feedback on reasoning subs-steps. For example, when an AI model generates a “bad” output but 90% of the reasoning or steps taken are correct, in the disclosed implementations the areas that are incorrect can be given specific feedback and re-trained. By contrast, prior systems may consider the entire output “bad” and require more extensive retraining and/or fine-tuning.

In some implementations the user interface can be configured to allow input by an unskilled user. While some artificial intelligence models require skilled engineers to interpret the output and provide feedback on AI generated outputs, in some of the disclosed implementations, user feedback can be provided by unskilled users using natural language. The user provided feedback may not require that a user be familiar with coding, the underlying features of the system in which the application is run, SQL, Python, and the like. In this manner, non-technical users may validate and correct the logic steps required to train and create models capable of delivering the desired output.

In some implementations the user input and feedback to chain of thought reasoning can be used to generate a revised response for the analytical task by the underlying artificial intelligence based model. The revised response can be generated by the AI- model which can be provided, for example, the feedback to the chain of thought reasoning, the chain of thought reasoning, the original prompt provided to the AI-model, as well as the originally generated response by the AI-model. In some implementations, the user feedback to the chain of thought reasoning (and corresponding analytical sub-steps taken by the underlying artificial intelligence model) can provide validation of output generated by the underlying artificial intelligence model. In this manner, the artificial intelligence model and/or agents can be updated continuously and the model can be self-learning with constant, iterative feedback provided by the user feedback to the chain of thought reasoning. In some implementations the user input and feedback to chain of thought reasoning can be used to generate a revised response for the analytical task by re-executing the artificial intelligence based model based on the received feedback 105. In some implementations, the user provided feedback to the chain of thought reasoning can provide insight into the quality of the reasoning sub-steps or responses or how “good” the generated responses and reasoning is, as opposed to merely looking at whether the sub-steps or responses generated by the AI model meet an expected type or format, and the like.

In some implementations, the method can also include re-training the artificial intelligence based model based on the feedback received from the user for the sub-step. In some implementations, the user feedback to the chain of thought reasoning can be collected and used to form a collection of training data which can be used to re-train the underlying AI-model. For example, collections of feedback from hundred, thousands, or millions of feedback to the chain of thought reasoning can be collected and used to retrain the underlying AI model. In some implementations, the underlying AI-model is re-trained once a threshold amount of feedback is collected.

In some implementations, various models trained with varying amounts of feedback to chain of thought reasoning can be evaluated to identify optimizations in the amount of user feedback to chain of thought reasoning required to re-train the underlying AI-model.

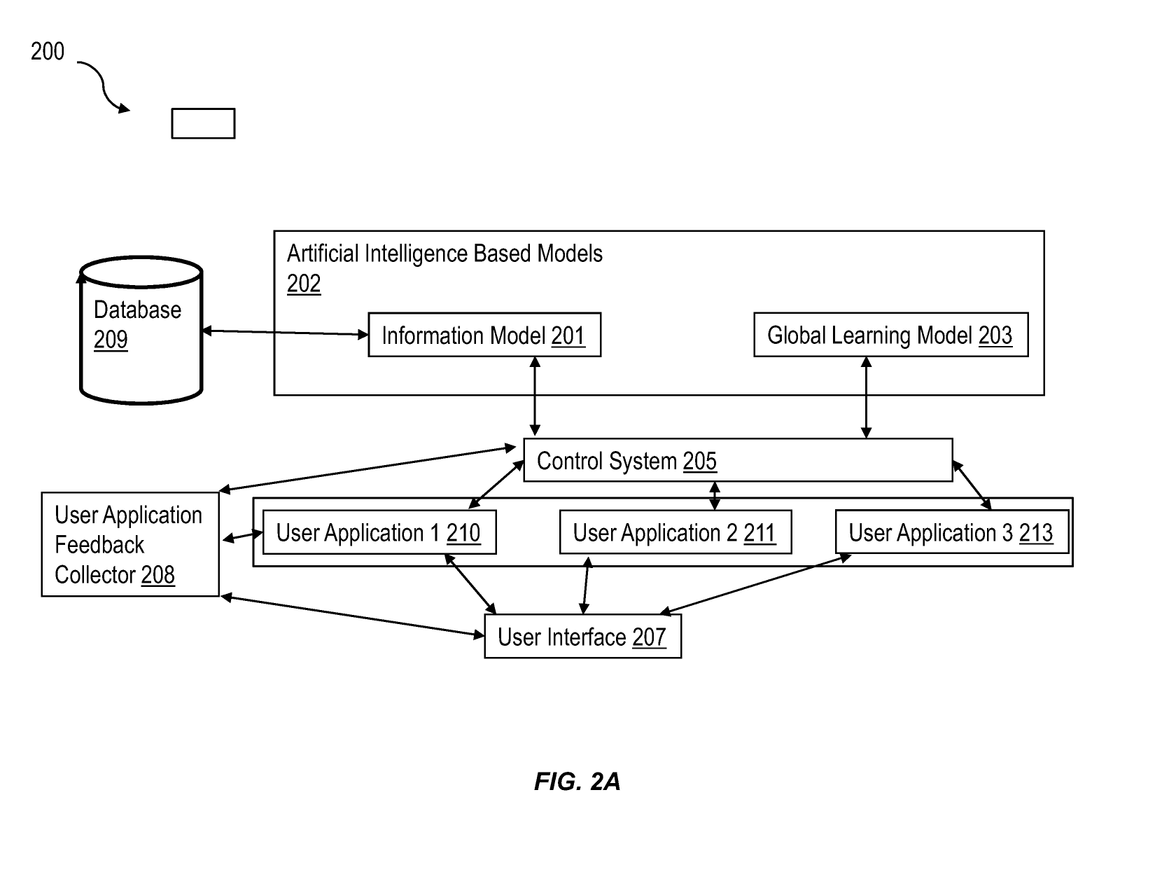

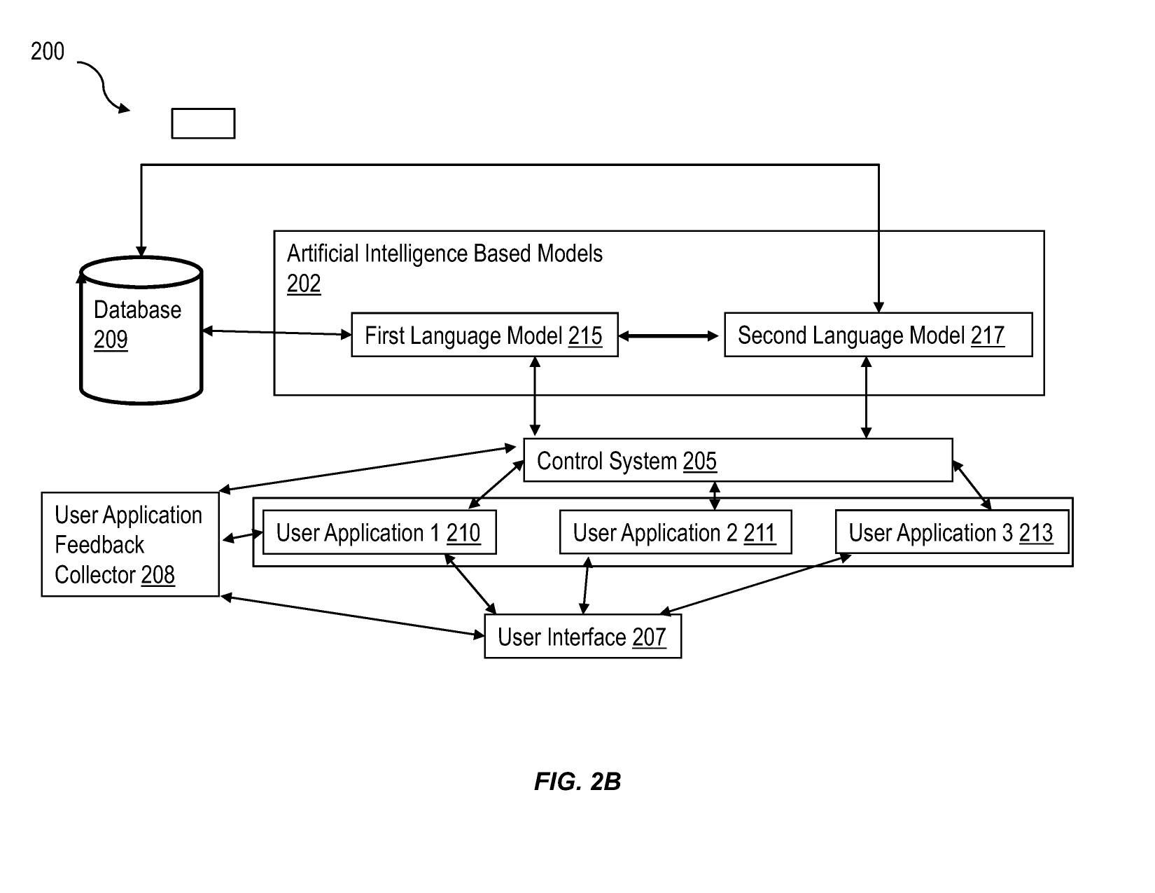

FIG. 2A is a system diagram for an example system for improved training of an artificial intelligence model. Illustrated is a system 200 for improved applications utilizing artificial intelligence models. For example, the system 200 may include artificial intelligence models 202, which may include information models 201, and/or frontier, foundational or global learning models 203. The artificial intelligence models 202 may be mediated by a control system 205. In some embodiments, the information model 201 may be communicatively coupled to a database 209 that includes enterprise specific data. The control system 205 may interface between the information model 201 and the foundational or global learning model 203. For example, the control system 205 may use the foundational or global learning model 203 to generate human comprehensible insights based on data and parameter sets provided by the information model 201. Additionally, the control system 205 may use the information model 201 to confirm the accuracy of output generated by the foundational or global learning model 203. Additionally, the control system 205 may use the information model 201 to access or edit information in the database 209. Additionally, the user interface 207 may be configured to allow inexpert users to confirm and accept the output of the combined system without requiring any data science expertise. One or more user applications 210, 211, or 213 can directly interact with the control system 205 and/or artificial intelligence based models 202. Examples of user applications 210, 211, 213 include, but are not limited to, document summarization applications, natural language queries, what’s new analysis, analytics, chat applications, and the like.

In some implementations, the database 209 and/or informational model 201 are optional components of a system for improved training of AI models. Systems for training AI models could use any number of retrieval augmented generation techniques (such as those described above) or alternatively, have an interaction between the AI model itself without a corresponding database such as database 209 and retrieval augmented generation.

As shown in FIG. 2A, a user application feedback collector 208 can be configured to collect feedback from the user on the model’s reasoning steps. The user application feedback collector 208 can be configured to collect feedback specific to one or more user applications. The collected feedback may allow a user to retrain the underlying AI model so that it produces more relevant, salient, or better responses. In some implementations, the collected feedback can be used to prompt the AI-model to produce a different response and therefore the user can be provided with an updated response in real-time. If the updated response is accurate while the original was not, that can be used to validate the effectiveness of the user feedback. This process can continue in a sequence where a user provides feedback on a reasoning step, the AI model tries again but fails, the user provides feedback on a different step, until the AI model responds correctly. In this manner, continuous, iterative validation of the responses generated by the AI model can be generated. In some implementations, the incorrect responses, feedback obtained by the user application feedback collector, and the second updated response can be stored in a training dataset that can be used to retrain the AI model once a substantial amount of training data is available.

In some embodiments, a system built in accordance with those described in FIG. 2, can include an informational model that includes customized retrieval augmentation generation for extraction of analytics information from structured data sets. In some embodiments, the analytics information can be for a business objective or include proprietary data. Additionally, an informational model such as 201 can be configured to generate natural language queries in the form of a SQL statement and the like that can be used for retrieval augmentation for queries sent to a language model such as a foundational or global learning model 203 for a response. Additionally, in some embodiments, the informational model can include one or more specialized templates that are compatible with semi-structured data. Accordingly, in some implementations, unstructured text can be retrieved by filtering through different structured fields. In this manner, in some implementations a combined vector database can be utilized more efficiently with full, unstructured capability.

In some embodiments, a user application that is configured to generate a response to a query provided by a user can include a multi-step process. In one example, in a first step, information may be retrieved from an informational model such as 201 using a language model, deterministic system, vector database and the like. In a second step, the retrieved information can be provided to a global model that can include a language model. In some implementations, a user application can include various settings for both the retrieval of information in the first step, and the interactions with the global model in the second step.

Contextual information and metadata linking a particular parameter set to an artificial intelligence model can be used to fine-tune the artificial intelligence based model. For example, the payload or data that was provided to the artificial intelligence model that resulted in a response that was indicated as being “good” by user feedback can be provided to the artificial intelligence model to retrain it based on the good response in addition to the context it was generated in. In this manner, metadata and contextual data is linked to better responses and used to retrain the artificial intelligence model in a way that reduces the occurrence of hallucinations.

Fine-tuning may include providing the user application and underlying informational models and/or global models with user feedback such as a positive, negative, neutral, thumbs up, thumbs down, or the like. In this manner user feedback can be used to create additional layers that interface between the informational model and global model that include domain specific information. For example, the user feedback for fine tuning can be provided by subject matter experts or by laypersons. In some implementations, Low Rank Adaptation (LoRA) or similar techniques can be used to fine tune training models.

In some implementations, as illustrated in FIG. 2B, a natural-language-to-SQL data flow is utilized. In such an embodiment, a user’s question is first interpreted by a first language model 215 that inspects dataset metadata to identify relevant fields and computations, then generates an executable SQL query against the underlying database 209. The database returns a payload (e.g., a table or scalar), which is then passed to a second language model 217 that synthesizes the final, user-facing answer. While the same reasoning pipeline can operate over an information model shown in FIG. 2A, where “chart information” or structured insights are provided downstream instead of raw SQL output, the SQL path in FIG. 2B may be able to process real-world metadata that is messy and ambiguous (e.g., “region” vs. “territory” vs. “geo”) and makes natural language queries brittle without iterative correction and fine-tuning. In some implementations, the system can utilize program code instead or in addition to the SQL such that program code can be generated and executed. The result of the execution can then be passed to the second language model 217. One example program code includes code written in python. Other programming languages can be implemented.

In some implementations, the architecture accommodates both the informational model setup of FIG. 2A and the natural-language-to-SQL setup of FIG. 2B. It preserves the information-model variant for robustness, and it augments the NLQ-to-SQL variant with feedback and fine-tuning so the system learns customer-specific semantics and consistently returns correct, explainable results.

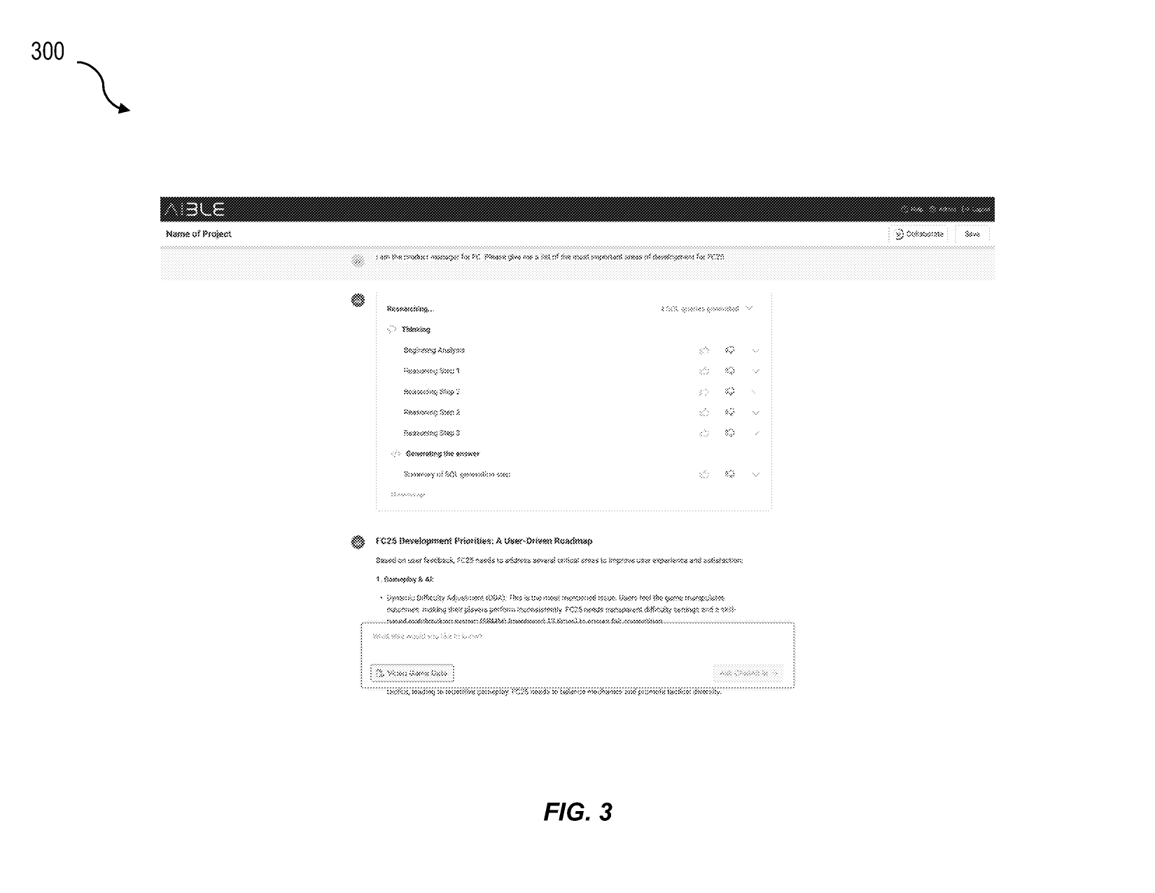

FIG. 3 is a graphical user interface for improved training of an artificial intelligence model. As illustrated, the graphical user interface may display the answer provided by the AI model (e.g., the answer), and a plurality of reasoning sub-steps. The collection of reasoning sub-steps taken by the AI model to generate the output for the prompt or query presented to the AI model can be referred to as the reasoning sequence. Each reasoning sub-step can be associated with one or more icons configured to receive user input (e.g., thumbs up thumbs down). In this manner a user may provide user feedback for each reasoning sub-step. As illustrated in FIG. 3 the system can be configured to provide the user with an indication of the reasoning used by the AI model to arrive at the generated response. In some embodiments, a “good” response generated by the AI-model to the prompt that was provided to the AI-model by the user can be indicative of the AI-model thinking about the answer and/or the prompt in a unique manner. Likewise a “bad” response generated by the AI-model can be indicative of the AI-model viewing the problem correctly in general, but for example, missing an assumption or skipping an important reasoning step. The user feedback can be provided in natural language form and interpreted by the AI-model into SQL commands and the like. The resulting SQL commands can be provided to the AI-model as it generates an improved response and/or training data.

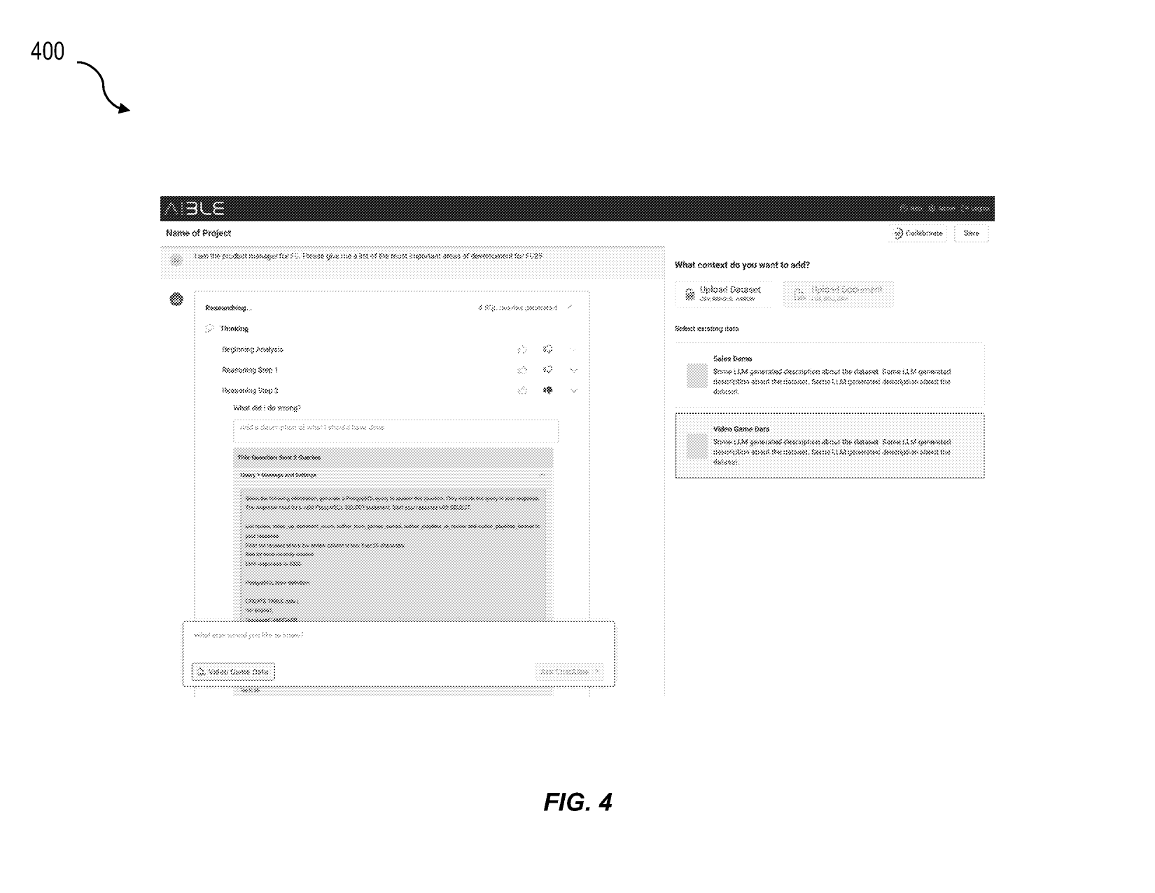

FIG. 4 is a graphical user interface for improved training of an artificial intelligence model. As shown in FIG. 4, when a user provides feedback that a reasoning sub-step is providing a “bad” response, the interface may be configured to provide the user with a textbox or other means to receive text indicating why the reasoning sub-step is incorrect or wrong. The received text may be in natural language form. Alternatively, or additionally the received text may be in SQL format, other coding languages or logic sequences. The user interface may be configured to display one or more details associated with the reasoning sub-step. For example, the user interface may display data associated with the reasoning sub-step. The user interface may also display the underlying queries that were provided to the AI model, the corresponding settings, the received responses and the like.

In the example illustrated in FIG. 4, a user identifies a problematic reasoning step. At this stage the user has reviewed the thinking and reasoning steps displayed by the system in the user interface and provided user feedback in the form of a thumbs down to indicate that the model made a mistake or failed to think through the problem as expected. The user provided feedback can include positive or negative feedback, which can be transmitted to the AI-model and used to help the AI-model understand what it did well or poorly. In some implementations, the user can also provide feedback in the form of text feedback. The text feedback may explain exactly what the AI-model did wrong and can be provided to the AI-model for generating a new, updated response, and/or for retraining the AI model. Additionally, the user can use the text-based feedback to re-prompt the AI-model with the feedback.

One or more of the reasoning steps displayed in the user interface can be accompanied by a headline. The headlines for each reasoning step can be provided and/or revised by the language model, by a secondary language model, or by human feedback.

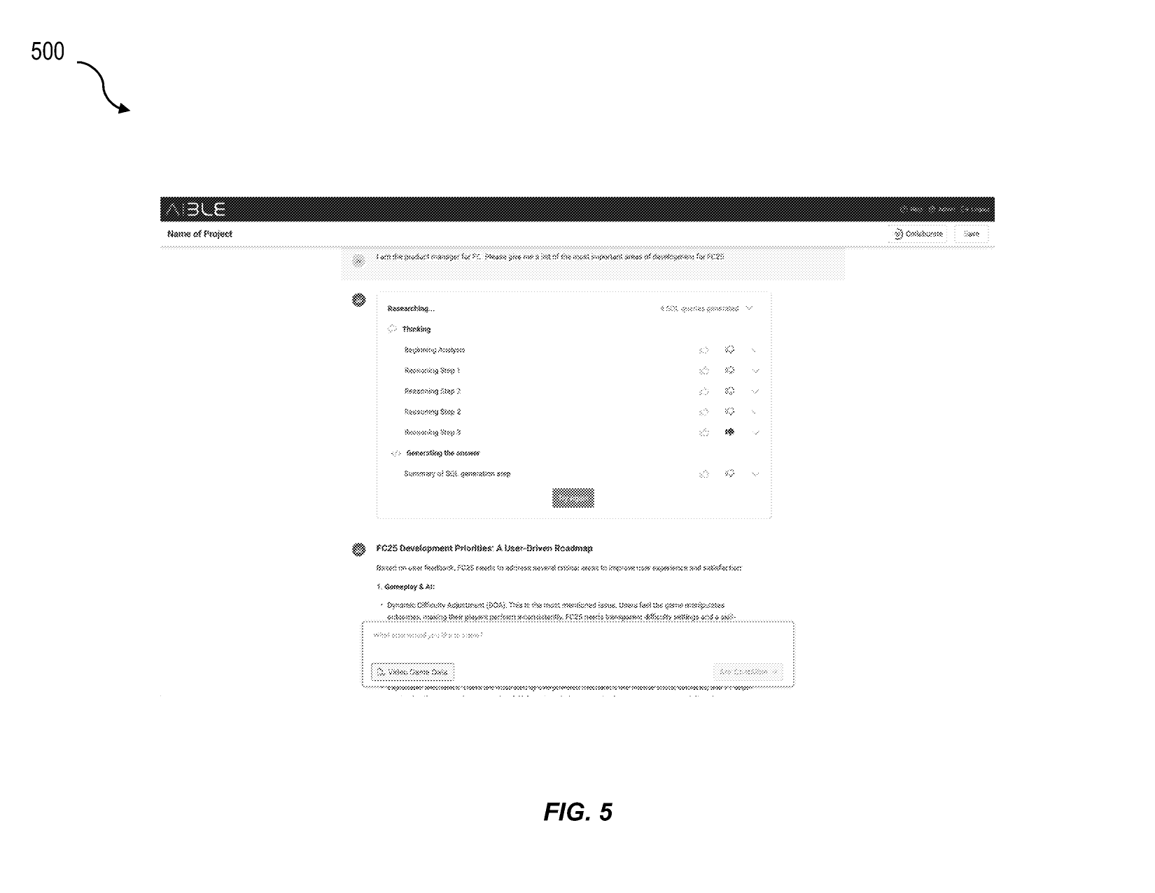

FIG. 5 is a graphical user interface for improved training of an artificial intelligence model. As illustrated, the user interface may prompt the AI model to generate an update response to the initial query after providing user feedback. As illustrated in FIG. 5, after a user has already provided feedback and the model can be prompted to try to generate a response again. Prior information can be fed to the model. Prior information and data can include, for example, the user question, prompt, retrieval augmented generation payload (if applicable) and response from the response that was “bad” as well as any user feedback to help the model on the next attempt. In some implementations, this data and information is used in an immediate one time manner for the AI-model to generate a response in a “try again” step. This process can be used to validate the effectiveness of the user feedback. The whole sequence of initial question, incorrect response, user feedback, try again, correct response can be saved as training data used for retraining the AI-model.

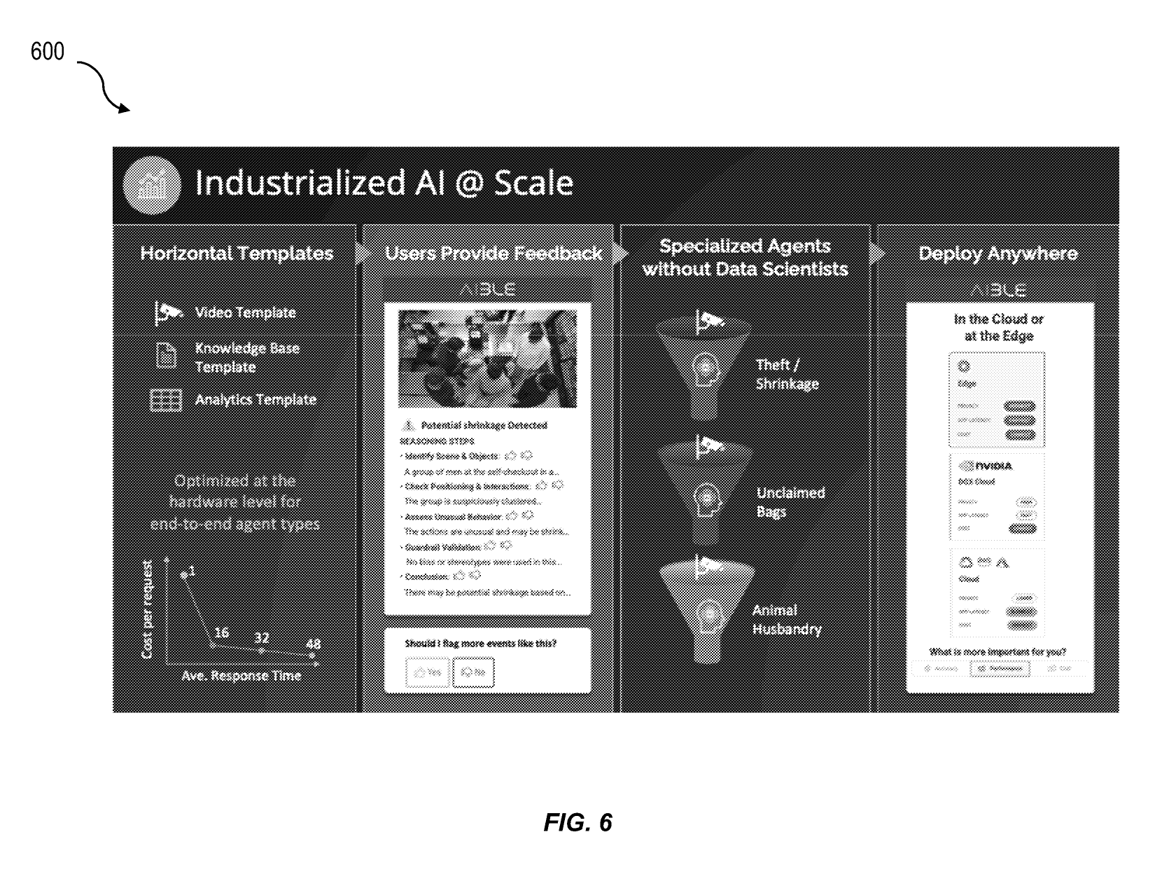

FIG. 6 provides an illustration of a platform for managing applications that interface with artificial intelligence based models. As shown, horizontal templates such as video templates, knowledge-based templates, and analytic templates can be optimized for particular users. The users may provide additional feedback. Specialized agents can process the provided feedback to improve and update the models and applications that are provided to a user. These models and applications can be deployed widely.

Although a few variations have been described in detail above, other modifications or additions are possible. For example, the described embodiments can be used in systems that do or do not utilize retrieval-augmented generation. The same approach can also be used in multi-modal environments such as reviewing a video to detect incidences of theft, etc.

The subject matter described herein provides many technical advantages. For example, AI models can be used to provide transparency in their reasoning and allow for user feedback that can be used to review and correct AI-generated responses without requiring specific user skillsets (e.g., coding). Further, AI-generated responses can be updated in real-time as the user provides feedback, the effectiveness of the user feedback can be automatically validated, and the validated feedback can be used for long-term re-training of the model.

Once models are re-trained, they can be automatically AZ tested against the original model to confirm that the re-trained model is indeed better than the original model for a specific use case. For example, in some implementations performance of models that are trained with varying constraints can be analyzed by techniques such as those discussed in “Analyzing performance of models trained with varying constraints” US Application No. 17/813,090, which is hereby incorporated by reference in its entirety.

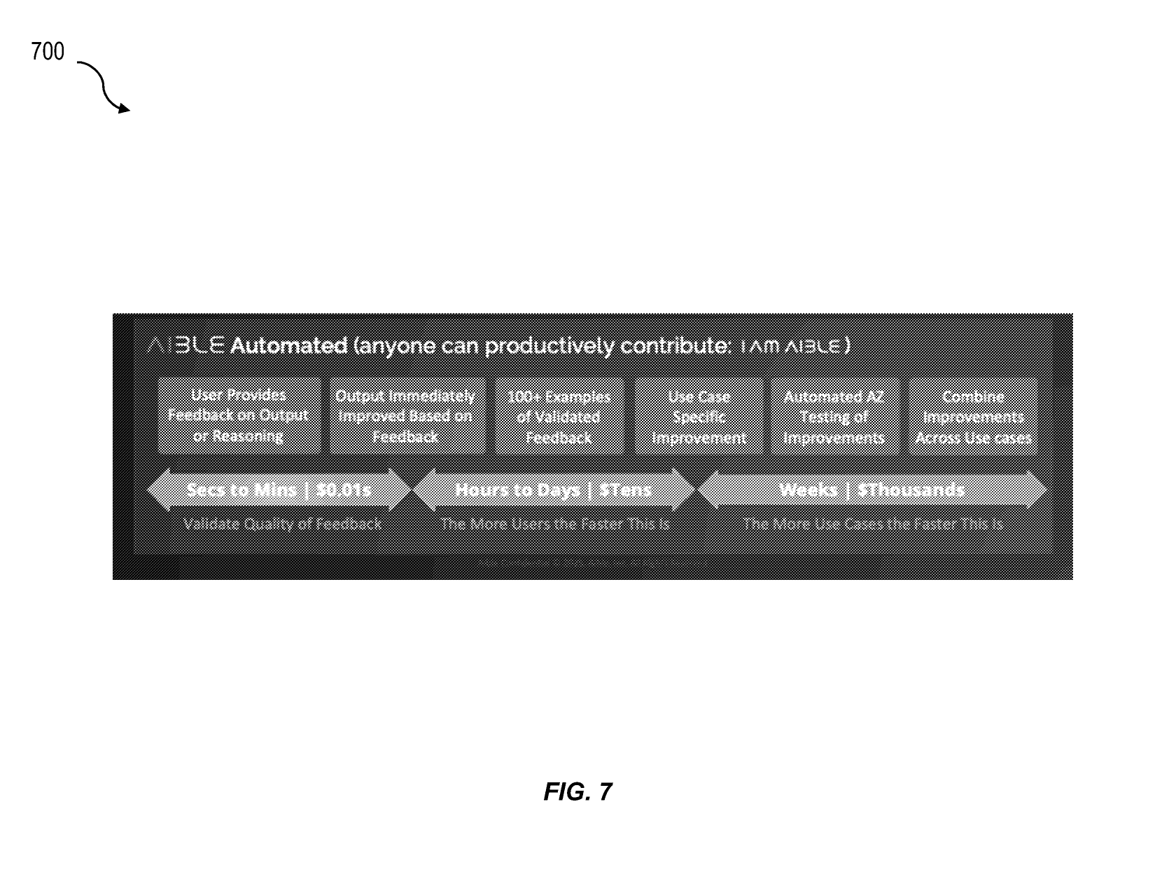

Some advantages of a system built in accordance with the present disclosure are illustrated in FIG. 7. In some implementations, a system built in accordance with the present disclosure can provide improvements to a model building process. For example, while conventional approaches may be restricted or limited by the availability of data scientists, the present disclosure can build a system that allows a naïve, unspecialized user to productively contribute towards the building of AI models and related systems. While conventional systems spend months and billions and millions of dollars on collecting public model training data, manual experimentation, re-trying when experiments fails, release revised models, collecting fine-tuning data, and manually fine-tuning models, the present disclosure results in a system that can more efficiently train models. As shown in FIG. 7, an example system may validate the quality of feedback on the order of seconds to minutes with minimal costs and resources used, and provide improvements within days to weeks. In some examples, a user may provide feedback on output or reasoning provided by an AI-model, the output can immediately be improved based on the user provided feedback. In this manner, hundreds of examples of validated feedback can be used to improve the model in a use case specific improvement. The use case specific improvements can be used to automatically modify and test a plurality of models. And improvements can be combined across use cases.

In some implementations the disclosed AI-models and related system can provide user-led improvement of AI-models. In some implementations, the AI models described herein may have access to enterprise-specific data. For example, the AI models can be trained on enterprise-specific data used within enterprise specific clouds for fine-tuning and reinforcement learning. The data quality of training data can be evaluated for quality and appropriateness by end-users who do not need to be technically skilled data scientists. In some implementations, feedback on reasoning can be collected easily from end users via an interactive interface. The user provided feedback can also include corrections of a model’s reasoning. In some implementations end users can provide feedback on accuracy at scale by simply selecting icons on an interactive interface (e.g., thumbs up/down) or by correcting existing AI-generated responses. By contrast, in some conventional systems, data scientists are required to focus on reinforcement learning, math, and logic problems due to the difficulty of collecting accuracy data. Accordingly, in conventional systems, certain models are specialized for certain tasks and not others. Additionally, in some implementations the disclosed systems are used to iteratively improve AI-models and subsequently generalize improvements. For example, user provided feedback is objectively and subjectively tested at user level use-case specific levels before the feedback is propagated to improve the underlying AI-model across various use-cases.

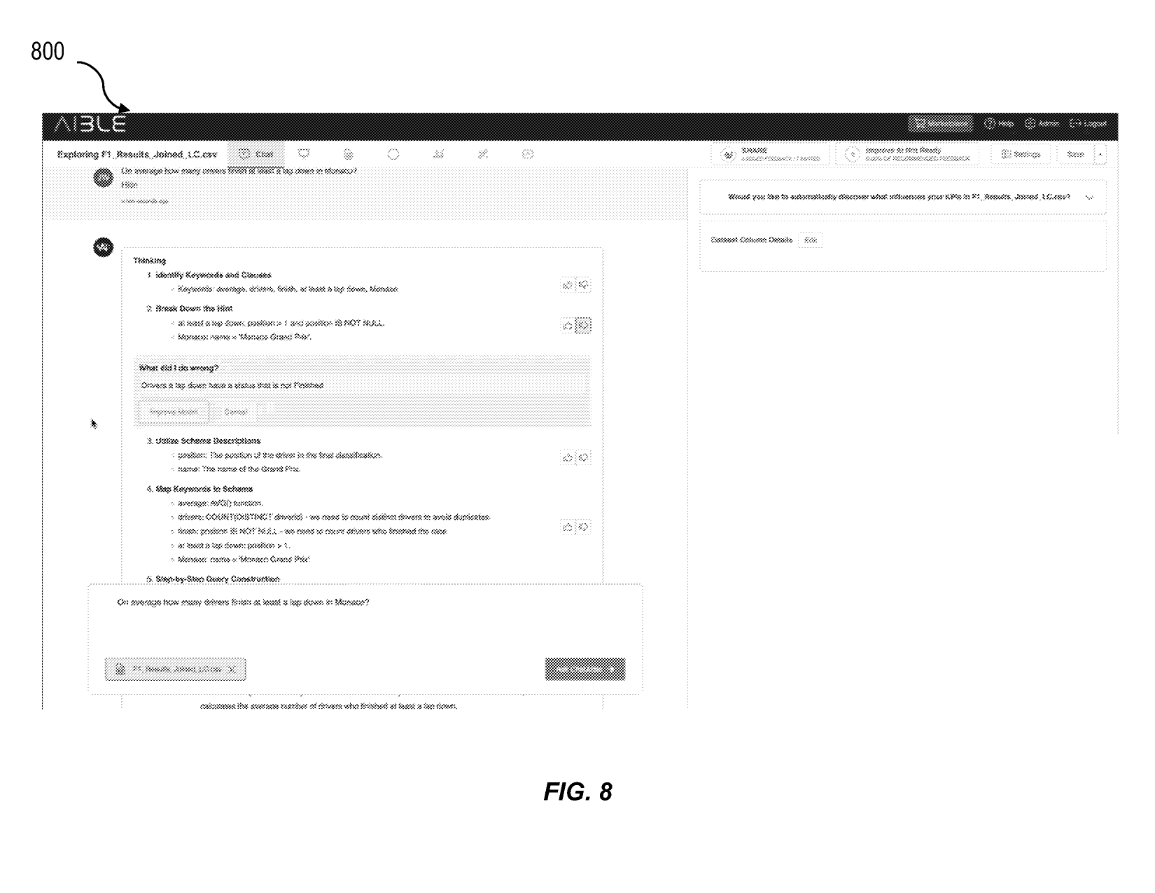

FIGS. 8-10 provide an illustration of a graphical user interface in which user feedback to chain of thought reasoning is provided. As shown in FIG. 8, the interface 800 may allow a user to input user feedback in natural language form.

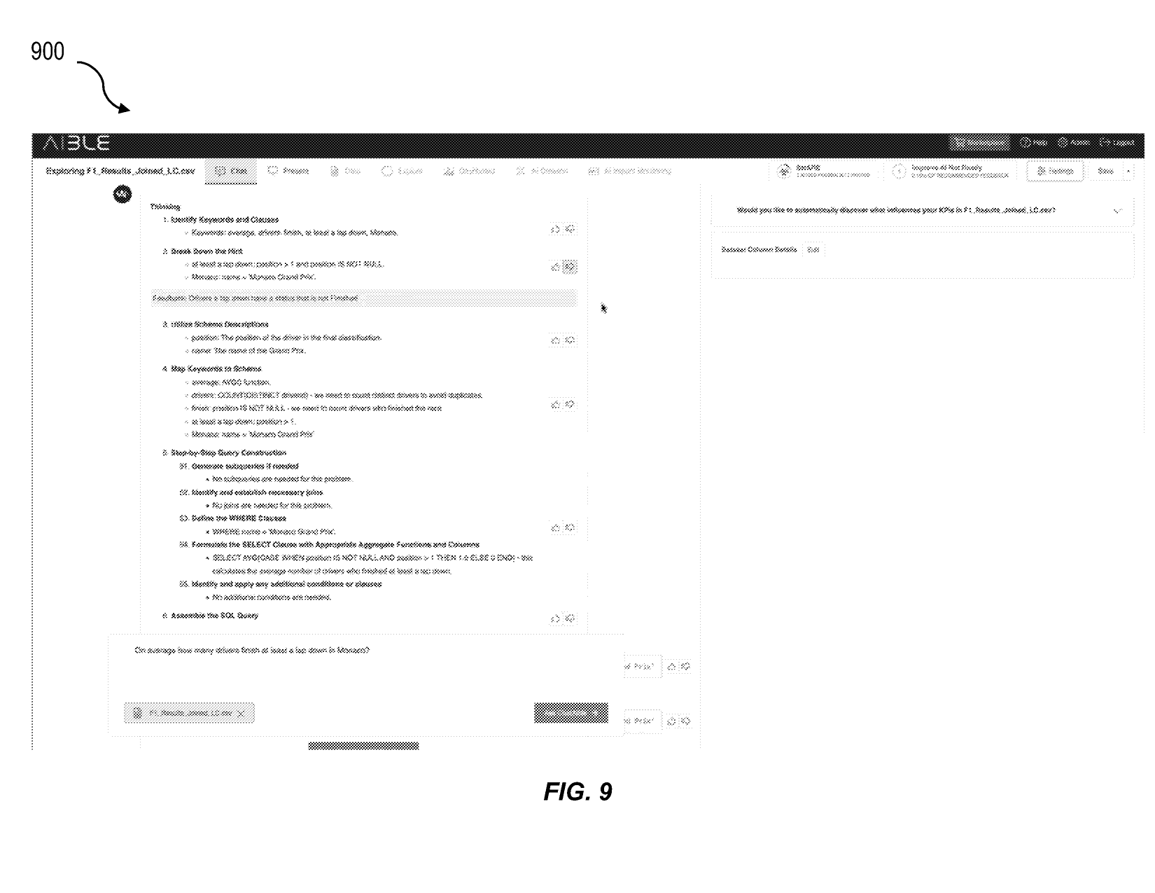

As shown in FIG. 9, in interface 900 the provided feedback can be used to update downstream reasoning steps taken by the model as shown in the chain of thought reasoning. Reasoning logic taken by the AI- model can be displayed including SQL queries and the like. However, the user is able to provide feedback and prompts and view responses in natural language. In this manner, highly skilled prompt engineers are not needed to interact with the AI-model. Moreover, in some implementations, fine-tuned reasoning tends to be more coherent and structured, avoiding the circular or contradictory “meandering” reasoning patterns that base models often produce when prompted to provide chain-of-thought explanations. Because, in some implementations, the desired reasoning patterns are embedded directly in the model, fine-tuning reduces the cognitive and computational load during inference, improving performance on smaller models that may struggle when required to generate complex reasoning via prompts.

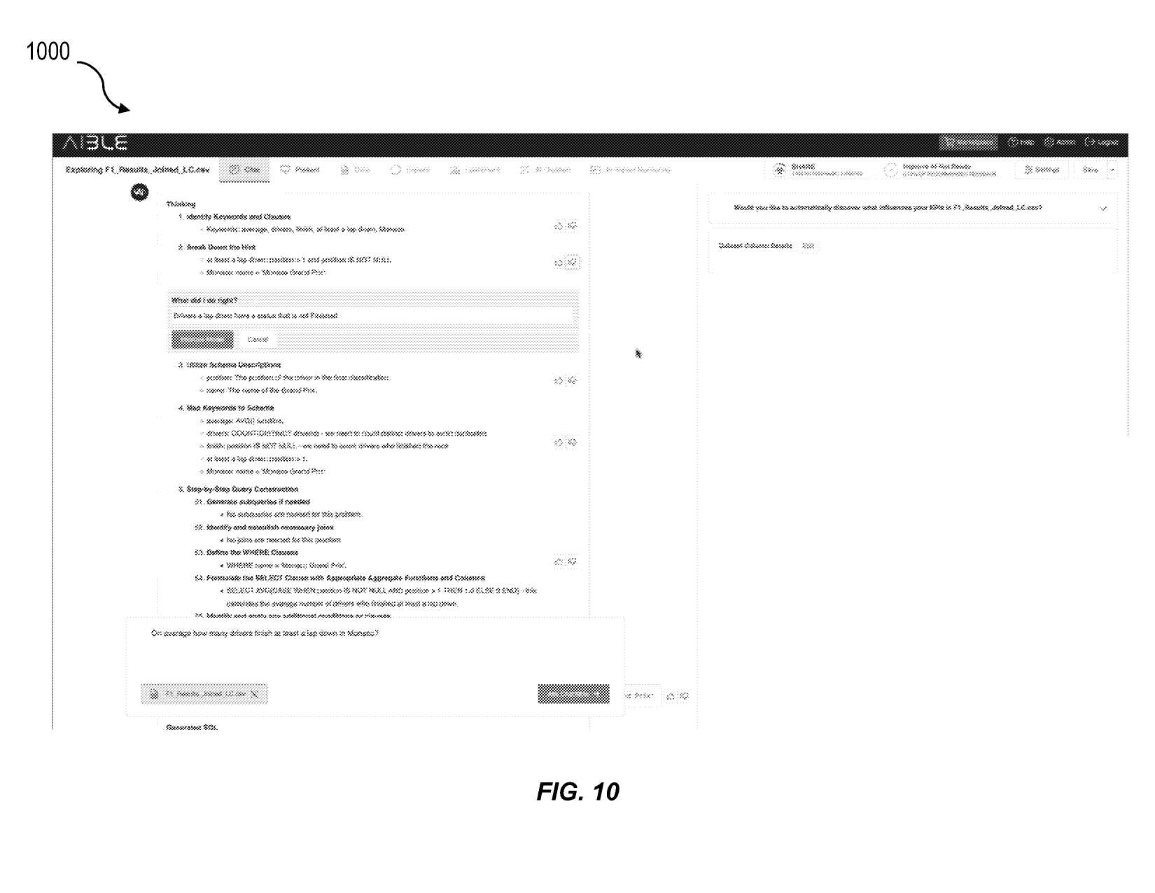

As shown in FIG. 10, in interface 1000 the provided feedback can be used to “improve model” which allows for the continuous instantaneous learning of the AI-model.

In some implementations, chain of thought reasoning may be associated with an increased cost that is levied on the underlying model. For example, smaller models may consume tokens and can degrade performance. Accordingly, in some implementations user feedback through SQL queries generated by the model, SQL query outputs, or textual outputs can still be used to generate corrective examples for fine-tuning even without chain-of-thought. In other words, even if the model does not output a written chain of thought, the SQL query it generates and the SQL results it receives can themselves be viewed as part of the model’s reasoning process. The SQL query encodes the model’s interpretation of the user’s question (e.g., what fields matter, what aggregation to run). The SQL output is the factual grounding the model uses to form its final answer. Together, these two elements form an implicit reasoning sequence, even though they are not written as explicit reasoning text.

In some implementations, fine-tuning a language model provides substantial advantages over prompt-only control because fine-tuning modifies the model’s underlying parameters to produce persistent behavioral changes, rather than relying on ephemeral, per-request prompting instructions. As a result, behaviors such as structured reasoning, consistent formatting, and agent-specific workflow logic become intrinsic to the model and are reproduced automatically without requiring repeated prompting. Fine-tuning also enables significantly greater accuracy for domain-specific tasks by exposing the model to curated examples that capture specialized terminology, inconsistent or noisy dataset schemas, user-specific conventions, and strict analytics or SQL-related reasoning requirements, all of which cannot be reliably addressed through prompting alone. Fine-tuning also enables the model to internalize semantic distinctions and resolve ambiguities such as organization-specific interpretations of fields like “region” or “territory”, by learning from corrective examples, thereby improving robustness even when metadata is incomplete or inconsistent. Finally, fine-tuning provides system-wide benefits across multi-agent pipelines because the corrections generated through the feedback loop enhance not only the reasoning model, but also the SQL-generation components, the natural-language response models, and any additional downstream agent interactions. In this way, prompting merely instructs the model on a one-off basis, whereas fine-tuning serves as a mechanism for permanently teaching the model the desired behaviors and interpretations.

In some implementations, the described techniques are applicable to tasks such as a document support task, unstructured task, or an analytical task. For example, the systems and methods described herein can be employed by a non-analytical agent.

The disclosed subject matter is directed to specific technological improvements in the functioning of artificial-intelligence systems, including mechanisms for generating and exposing a model’s reasoning sequence at the level of individual reasoning sub-steps, capturing user feedback aligned to those sub-steps through a graphical user interface, re-executing the model to produce revised responses conditioned on that feedback, and automatically retraining the model (e.g., via fine-tuning, low-rank adaptation, distillation, or reinforcement learning) using validated corrective examples generated by this iterative loop. These features improve the operation of AI models by reducing hallucinations, increasing accuracy, accelerating training, and enabling reliable reasoning behavior.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
providing an artificial intelligence-based reasoning sequence comprising one or more artificial intelligence reasoning sub-steps indicative of a logical process executed by an artificial intelligence based model to execute an analytical task;
receiving feedback from a user for a sub-step of the one or more artificial intelligence reasoning sub-steps; and
generating a revised response for the analytical task by re-executing the artificial intelligence based model based on the received feedback.

2. The method of claim 1, wherein the analytical task comprises processing structured or unstructured data to generate an analytical output.

3. The method of claim 2, wherein the analytical output comprises at least one of a classification, a prediction, a summary, an insight, a ranked list, or a recommended action.

4. The method of claim 1, wherein the logical process executed by the artificial intelligence based model to execute the analytical task comprises:
interpreting a natural-language query;
retrieving data relevant to the query from an information model or a database;
applying one or more machine-learning-based or rule-based reasoning steps to the retrieved data; and
generating a natural-language or structured response based on an output of the one or more machine-learning-based or the rule-based reasoning steps.

5. The method of claim 1, wherein the analytical task comprises:
converting a natural-language question into a structured query language (SQL) statement;
executing the SQL statement against a database to obtain a result set; and outputting an answer based at least in part on the result set.

6. The method of claim 1, further comprising:
re-training the artificial intelligence based model based on the feedback received from the user for the sub-step.

7. The method of claim 1, wherein the feedback comprises data indicative of the artificial intelligence reasoning sub-step and the user provided feedback.

8. The method of claim 1, wherein re-training further comprises fine-tuning the artificial intelligence model.

9. The method of claim 1, wherein re-training further comprises conducting reinforcement-learning of the artificial intelligence model.

10. The method of claim 9, wherein re-training the model comprises low-rank adaptation.

11. The method of claim 1, wherein the artificial intelligence-based reasoning sequence is provided in a graphical user interface, wherein each of the one or more artificial intelligence reasoning sub-steps is displayed, and the graphical user interface further comprises one or more selectable icons associated with each sub-step and/or a textbox configured to receive user feedback.

12. The method of claim 11, wherein the feedback from the user comprises text input, and/or a selection of an icon.

13. The method of claim 1, wherein the feedback from the user comprises SQL queries generated by the model, SQL query outputs, program code, python code, or textual outputs without chain-of-thought.

14. A system comprising:
at least one data processor; and
memory storing instructions, which when executed by the at least one data processor, cause the at least one data processor to perform operations comprising:
providing an artificial intelligence-based reasoning sequence comprising one or more artificial intelligence reasoning sub-steps indicative of a logical process executed by an artificial intelligence based model to execute an analytical task;
receiving feedback from a user for a sub-step of the one or more artificial intelligence reasoning sub-steps; and
generating a revised response for the analytical task by re-executing the artificial intelligence based model based on the received feedback.

15. The system of claim 14, wherein the analytical task comprises processing structured or unstructured data to generate an analytical output.

16. The system of claim 15, wherein the analytical output comprises at least one of a classification, a prediction, a summary, an insight, a ranked list, or a recommended action.

17. The system of claim 14, wherein the logical process executed by the artificial intelligence based model to execute the analytical task comprises:
interpreting a natural-language query;
retrieving data relevant to the query from an information model or a database;
applying one or more machine-learning-based or rule-based reasoning steps to the retrieved data; and
generating a natural-language or structured response based on an output of the one or more machine-learning-based or the rule-based reasoning steps.

18. The system of claim 14, wherein the analytical task comprises:
converting a natural-language question into a structured query language (SQL) statement;
executing the SQL statement against a database to obtain a result set; and outputting an answer based at least in part on the result set.

19. The system of claim 14, wherein the operations further comprise retraining the artificial intelligence-based model based on the feedback received from the user for the sub-step.

20. The system of claim 14, wherein the feedback comprises data indicative of the artificial intelligence reasoning sub-step and the user-provided feedback.

21. The system of claim 14, wherein retraining the artificial intelligence-based model further comprises fine-tuning the artificial intelligence-based model.

22. The system of claim 14, wherein retraining the artificial intelligence-based model further comprises conducting reinforcement learning of the artificial intelligence-based model.

23. The system of claim 22, wherein retraining the artificial intelligence-based model comprises low-rank adaptation.

24. The system of claim 22, wherein the artificial intelligence-based reasoning sequence is provided in a graphical user interface, wherein each of the one or more artificial intelligence reasoning sub-steps is displayed and the graphical user interface further comprises one or more selectable icons associated with each sub-step and/or a textbox configured to receive user feedback.

25. The system of claim 14, wherein the feedback from the user comprises SQL queries generated by the model, SQL query outputs, program code, python code, or textual outputs without chain-of-thought.
